(19) United States
(12) Patent Application Publication
(10) Pub. No.: US 2016/0261673 A1
(43) Pub. Date: Sep. 8, 2016

(54) EVALUATION OF COMPOSITION RULES USED FOR GENERATION OF DIGITAL CONTENT

(71) Applicant: International Business Machines Corporation, Armonk, NY (US)

(72) Inventors: Carlos H. Cardonha, Sao Paulo (BR); Fernando L. Koch, Sao Paulo (BR); Ademir F. Da Silva, Sao Paulo (BR)

(21) Appl. No.: 14/639,568

(22) Filed: Mar. 5, 2015

(51) Int. Cl. H04L 29/08

(52) U.S. Cl. CPC H04L 67/06

(57) ABSTRACT

In an approach to evaluating generation of digital content, a computer processor receives a request for a digital content to be sent to a mobile computing device of a user. The computer processors retrieves a plurality of local context information from the mobile computing device, and generates the digital content, based, at least in part, on the request and a first set of composition rules. The computer processor sends the digital content to the mobile computing device and then retrieves a plurality of user interaction information from the mobile computing device. The computer processor analyzes the plurality of local context information and the plurality of user interaction information.

### BACKGROUND OF THE INVENTION

The present invention relates generally to the field of mobile computing, and more particularly to evaluation of composition rules used for generation of digital content to be used by mobile computing devices with interactive interfaces.

Typically, educational or learning materials are developed and distributed based on certain factors, such as level of expertise, planned use, and planned environment for reviewing the materials. However, a student or employee may not always have the required level of expertise, or request, receive, or use the information in the environment envisioned. For example, rules to generate an employee information packet may envision the employee reviewing the information while seated at a work station, however, many employees work on a mobile computing device while traveling and the format of the packet may not be suitable for the mobile computing device. With the increase in available mobile computing technologies, many companies and institutions, including, but not limited to, educational or vocational training operations, may wish to develop and distribute information and materials to users in the field.

### SUMMARY

Embodiments of the present invention disclose a method, a computer program product, and a computer system for evaluating generation of digital content. The method may include a computer processor receiving a request for a digital content to be sent to a mobile computing device of a user and retrieving a plurality of local context information from the mobile computing device. The computer processor then generates the digital content, based, at least in part, on the request and a first set of composition rules and sends the digital content to the mobile computing device. The computer processors retrieves a plurality of user interaction information from the mobile computing device, and then analyzes the plurality of local context information and the plurality of user interaction information.

### BRIEF DESCRIPTION OF THE DRAWINGS

FIG. 1 is a functional block diagram illustrating a data processing environment, in accordance with an embodiment of the present invention;

FIG. 2 is a flowchart depicting operational steps of an evaluation program, for generating digital content, collecting information on use and interaction with the digital content, and generating one or more reports based on analysis of the collected information, in accordance with an embodiment of the present invention;

FIG. 3 illustrates operational steps of an analytics module, for analyzing information collected on use and interaction with the digital content generated by the evaluation program of FIG. 2, in accordance with an embodiment of the present invention; and

FIG. 4 is a block diagram of components of a data processing system, such as the server computing device of FIG. 1, in accordance with an embodiment of the present invention.

### DETAILED DESCRIPTION

Technological advances in mobile computing have allowed users, including, for example, employees and students, to receive and use digital content, for example, educational and learning materials, in the field, as well as in a work or home environment. However, each field environment may contain varying parameters, and each user may interact with digital content differently than another user. Embodiments of the present invention recognize that a user of digital content may require a format of the content more suitable for a specific environment or the specific user than the format envisioned by the original rules used to generate the digital content.

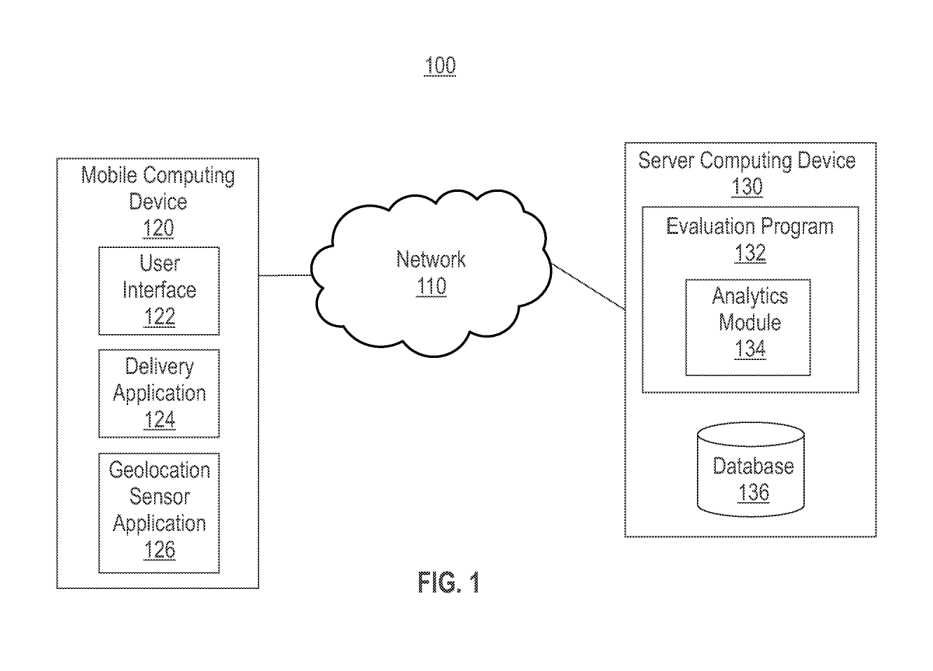

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the environments in which different embodiments may be made by those skilled in the art without departing from the scope of the invention as recited by the claims.

Data processing environment 100 includes mobile computing device 120 and server computing device 130, interconnected via network 110. Network 110 can be, for example, a telecommunications network, a local area network (LAN), a wide area network (WAN), such as the Internet, or a combination of the three, and can include wired, wireless, or fiber optic connections. Network 110 may include one or more wired and/or wireless networks that are capable of receiving and transmitting data, voice, and/or video signals, including multimedia signals. In general, network 110 can be any combination of connections and protocols that will support communications between mobile computing device 120, server computing device 130, and other computing devices (not shown) within data processing environment 100.

Mobile computing device 120, in various embodiments, can be a laptop computer, a tablet computer, a smartphone, or any programmable electronic device capable of communicating with server computing device 130 via network 110, and with various components and devices (not shown) within data processing environment 100. Mobile computing device 120 may be a wearable computer. Wearable computers are electronic devices that may be worn by the bearer under, with, or on top of clothing, as well as in glasses, hats, wigs, or other accessories, and are capable of receiving, processing, storing, sending, and displaying data. In an exemplary embodiment, mobile computing device 120 is a tablet computer or smartphone and includes a touchable, interactive user interface. In general, mobile computing device 120 represents any programmable electronic device capable of executing machine readable program instructions and communicating with other computing devices via a network, such as network 110. While depicted in FIG. 1 as a single mobile computing device, in various embodiments, mobile computing device 120 may represent one, or a plurality of mobile computing devices. Mobile computing device 120 includes user interface 122, delivery application 124, and geolocation sensor application 126.

User interface 122 provides an interface between a user of mobile computing device 120 and server computing device 130. User interface 122 may be a graphical user interface (GUI) or a web user interface (WUI), and can display text, documents, web browser windows, user options, application interfaces, instructions for operation, multimedia content, and other such digital content. User interface 122 includes the information (such as graphic, text, and sound) that a program presents to a user and the control sequences the user employs to control the program. User interface 122 may be mobile application software that provides an interface between a user of mobile computing device 120 and server computing device 130. Mobile application software, or an “app”, is a computer program designed to run on smart phones, tablet computers, and other mobile devices.

Delivery application 124 resides on mobile computing device 120 and operates to play received digital content on the mobile computing device, collect information on context and use of digital content on the mobile computing device. The information collected can be user interaction information, for example, a user's manipulation on-screen of the digital content, or a user's response (feedback) to the digital content. Information collected by delivery application 124 is retrieved by evaluation program 132, residing on server computing device 130 in data processing environment 100.

Geolocation sensor application 126 operates on mobile computing device 120 to collect and store local context information for the environment in which mobile computing device 120 is located. For example, the information collected may be situational and environmental information on where the digital content may be viewed. Information collected by geolocation sensor application 126 can be retrieved by evaluation program 132. In an embodiment, delivery application 124 receives the local context information for the mobile computing device.

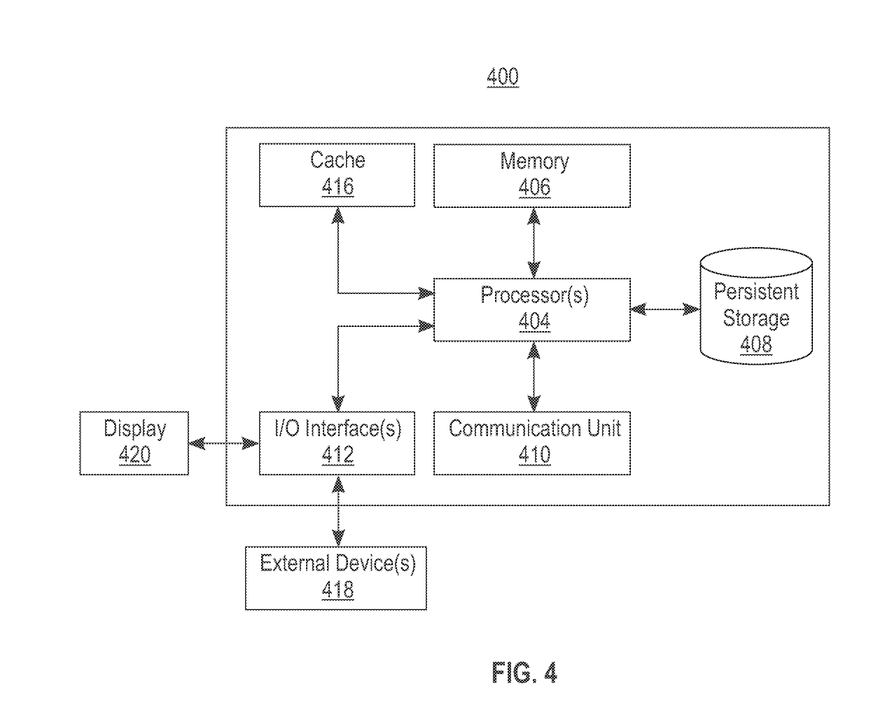

In various embodiments, server computing device 130 can be a standalone computing device, management server, a web server, a mobile computing device, or any other electronic device or computing system capable of receiving, sending, and processing data. In other embodiments, server computing device 130 can represent a server computing system utilizing multiple computers as a server system. In another embodiment, server computing device can be a laptop computer, a tablet computer, a netbook computer, a personal computer, a desktop computer, or any programmable electronic device capable of communicating with other computing devices (not shown) within data processing environment 100 via network 110. In another embodiment, server computing device 130 represents a computing system utilizing clustered computers and components (e.g., database server computers, application server computers, etc.) that act as a single pool of seamless resources when accessed within data processing environment 100. Server computing device 130 includes evaluation program 132, analytics module 134, and database 136. In various embodiments, each of the program, module, and database included on server computing device 130 may be located elsewhere within data processing environment 100 with access to mobile computing device 120 via network 110. In an embodiment of the present invention, the functions and capabilities of analytics module 134 can be performed by evaluation program 132. Server computing device 130 may include internal and external hardware components, as depicted and described with reference to FIG. 4.

Evaluation program 132 receives a request for digital content, for example, a maintenance manual, from a mobile computing device, for example, mobile computing device 120 in data processing environment 100. Upon receiving the request, evaluation program 132 retrieves local context information from the mobile computing device in order to determine situational information about the environment in which the mobile computing device is located and in which the digital content may be consumed. Evaluation program 132 generates the digital content using one or more composition rules, and sends the digital content to a mobile computing device of a user in the field. An application on the mobile computing device, for example, delivery application 124, collects information on the user's interaction with the digital content, and evaluation program 132 retrieves the collected information. The information is stored and analyzed in order to generate one or more reports. Based on the one or more reports, evaluation program 132 determines whether an adjustment to the composition rules used to create the digital content is received, and if so, uses the adjustments to create an additional revised set of composition rules in order to generate digital content.

Analytics module 134 evaluates and analyzes the retrieved and stored information per part of the digital content, based on the user, the user interaction information, the local context information, and the composition rules used to create each part, to determine an evaluation of each part of the digital content, and to calculate a quality of the digital content. The analysis is used by evaluation program 132 to generate one or more reports on the digital content.

Database 136 resides on server computing device 130. A database is an organized collection of data. Database 136 can be implemented with any type of storage device capable of storing data that can be accessed and utilized by mobile computing device 120 and server computing device 130, such as a database server, a hard disk drive, or a flash memory. In other embodiments, database 136 can represent multiple storage devices within data processing environment 100 or within server computing device 130. In various embodiments, database 136 may represent zero to many databases. Database 136 stores, for example, composition rules used in order to generate digital content, user profile information, information identifying parts of the digital content, and tables generated and analyzed by evaluation program 132 and analytics module 134. The tables can include, for example, tables associating composition rules used to create a part of the digital content, local context parameters per user, or per digital content, an evaluation of per user per part, or a classification of a digital content's quality, as generated by analytics module 134. A part of a digital content may be a paragraph, a page, a table, a chapter, or a portion of a screen display of the digital content.

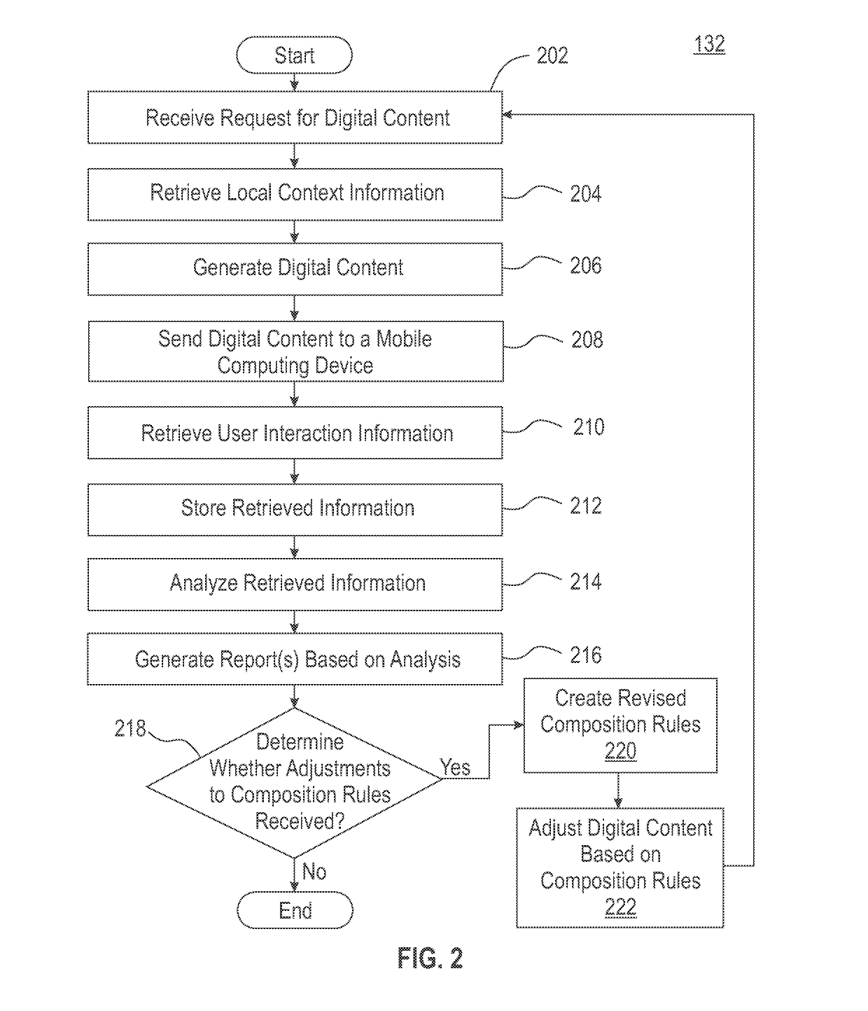

FIG. 2 is a flowchart depicting operational steps of an evaluation program, for generating digital content, collecting information on use and interaction with the digital content, and generating one or more reports based on analysis of the collected information, in accordance with an embodiment of the present invention.

Evaluation program 132 receives a request for digital content (202). A request for digital content can be sent by a user of a mobile computing device, such as mobile computing device 120, to server computing device 130. The request may contain, for example, identifying information on what digital content is requested, an environment in which the user is located, and user profile information.

Evaluation program 132 retrieves local context information (204). Evaluation program 132 communicates with mobile computing device 120, more specifically with geolocation sensor application 126 on mobile computing device 120, to retrieve local context information about the environment surrounding the mobile computing device. Local context information can include, for example, a time, or time period, a location, one or more activities, a social setting, or a culture, and can reflect situational information about the environment in which a user is operating mobile computing device 120 and may consume the digital content. Local context information may indicate, for example, a field worker requires training material with only a short time available to review, in a dark area, and in an emergency situation.

Evaluation program 132 generates the digital content (206). Evaluation program 132 generates digital content automatically based on composition rules stored and processed by evaluation program 132. The digital content may be, for example, vocational content, such as instructions on how to implement maintenance for specific machinery. The composition rules can be stored in database 136 on server computing device 130. Composition rules may contain parameters that take into consideration a user's profile, including the user's previous exposure to a target scenario and characteristics of the environment, such as a location, tasks involved, and schedule. Composition rules may also include parameters for a topic, and/or a group profile.

Evaluation program 132 sends digital content to a mobile computing device (208). In the exemplary embodiment, the mobile computing device, for example, mobile computing device 120, includes an interactive interface, such as a tablet computer with a touch screen. The mobile computing device is capable of playing the digital content and displaying the digital content on a user interface, such as user interface 122.

Evaluation program 132 retrieves user interaction information (210). During the, work, for example, maintenance on specific machinery, a user interacts with the digital content. Evaluation program 132 retrieves user interaction information by communicating with delivery application 124 on mobile computing device 120. User interaction information can include, for example, intentional interaction and non-intentional interaction. Intentional interaction may be determined using “feedback markers” which can receive information from a user using question and answer format, surveys, or other means in which a user may input information. For example, a feedback marker may be a pair of icons through which a user reports on his or her perception about the quality of the material being presented, such as a red “X” and a green “Y”, where the former denotes a negative impression, and the latter a positive one. Non-intentional interaction can include a user's tactile manipulation of the display on the user interface of the device, one or more gestures performed by the user, a time to change pages, contact, tapping, or other manipulation of the digital content by the user, including zooming actions. The non-intentional interaction may be performed by a user's finger, a style, eye gaze detection, voice control, or other known methods of interacting with a computing device display.

Evaluation program 132 stores the retrieved information (212). Evaluation program 132 stores and indexes the retrieved information, including local context information and user interaction information, in a database, such as database 136 of server computing device 130. In an exemplary embodiment, the non-intentional user interaction information and the intentional user interaction information are each stored in a table associating the interaction per user per part of the digital content. The non-intentional user interaction information may be stored in the table according to what gesture or manipulation the user performed per part of the digital content. Additionally, in the exemplary embodiment, the local context information is stored in a table associating the local context parameters, such as time, location, and social setting, per user.

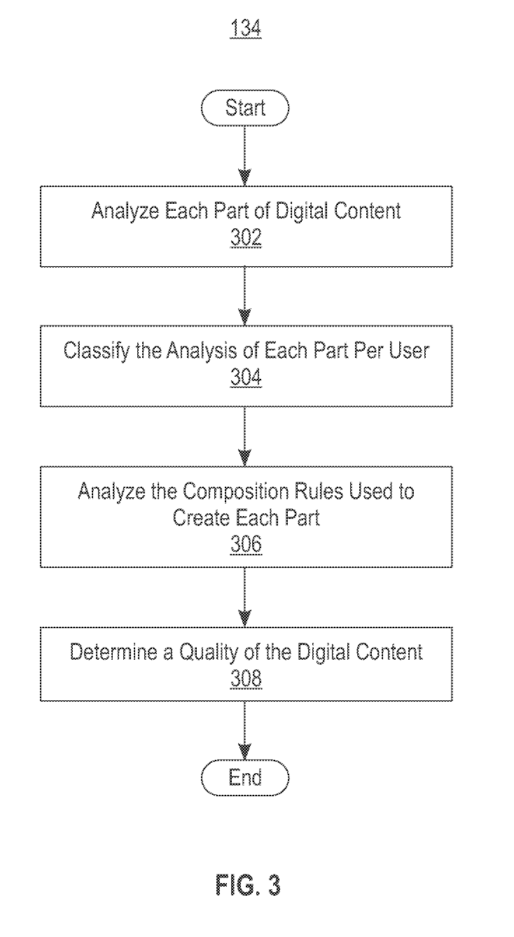

Evaluation program 132 analyzes the retrieved information (214). In the exemplary embodiment, evaluation program 132 analyzes the retrieved information utilizing analytics module 134, the steps of which are shown in FIG. 3. FIG. 3 illustrates operational steps of analytics module 134, for analyzing information collected on use and interaction with the digital content generated by evaluation program 132, in accordance with an embodiment of the present invention. Analytics module 134 can be used to evaluate the fitness of a part of the digital content for the user and for the context in which the content is to be consumed. Analytics module 134 analyzes each part of the digital content based on user profile information, user interaction patterns, and local context using a classification algorithm to correlate the retrieved and stored information with user profile information (302). As discussed above, the user profile information can be stored in database 136, and can classify users based on demographics, psychographics, and historic information related to consumption of digital content. Analytics module 134 can analyze the influence of certain context parameters on a user's interaction with the digital content. Analytics module 134 classifies the analysis of each specific part of the digital content to certain users, based on how the user interacts and reacts to the digital content material in a certain context (304). In various embodiments, analytics module 134 can generate a table associating an evaluation of a user per part, where the evaluation is the suitability of the specific digital content part for the user in the local context where the digital content was consumed.

Additionally, analytics module 134 analyzes the composition rules used to generate the digital content using a classification algorithm, and based on results, can generate a table associating an evaluation of a specific part with a composition rule used to create that part (306). Analytics module 134 determines a quality of the composed digital content, using a classification algorithm to calculate an overall rating based on the evaluation of the composition rules per part (308). In various embodiments, the overall rating considers the evaluation of the composition rules based on local context information as well. The digital content may be given a quality classification in a given metric, for example, low, average, or good.

In various other embodiments, evaluation program 132 implements modeling techniques to model the retrieved information, including any distinct features of the retrieved information. Evaluation program 132 correlates the distinct features of the retrieved information with composition rules, parameters of local context, and individual profiles.

Evaluation program 132 generates report(s) based on the analysis (216). A report can be generated based on a summary of the classification of the digital content quality and the evaluation of composition rules per part, as determined by analytics module 134. Generated reports can include context and utilization patterns for the digital content, which can be used to indicate suitability, or un-suitability, of a composed digital content for a target environment in which it is being consumed or a target audience. In an embodiment, a report may include a summary of a group reaction to the generated digital content in terms of organization of memory and learning, focus and attention, perception, categorization and preference, motivation and performance, and other group and individual profile information. In another embodiment, a report may contain a recommendation to adjust the digital content material for a specific user and/or a specific context.

Evaluation program 132 determines whether adjustments to the composition rules are received (decision block 218). If adjustments to the composition rules are received (decision block 218, “yes” branch), then evaluation program 132 uses the adjustments to create revised composition rules (220) and adjusts the digital content based on the revised composition rules (222). The adjustments may be determined, based on a difference between the user interaction information and user profile information of the user. For example, a user profile may indicate the user has normal eye sight or typically wears corrective lenses, however, the user interaction information may indicate the user zooms in on each screen presented. The adjustment to the digital content may include increasing font size. Evaluation program 132 then returns to wait to receive a request for digital content. The adjusted digital content may contain, for example, a revised format for presentation of the material. Generated reports can be used to evaluate quality of the digital content, and thus quality of the composition rules used. The generated reports can be analyzed by a system administrator, an educator, a manager, or another party to adjust the composition rules with an aim towards customizing the digital content for the environment and the user. For example, composition rules to create digital content with shorter videos, summarized text, or a different configuration of material, may be used in response to a location and timing of an activity, or in response to cultural characteristics of a target audience.

If there are no adjustments to the composition rules (decision block 218, “no” branch), then evaluation program 132 ends processing.

FIG. 4 depicts a block diagram of components of a computer system 400, which is an example of a system such as server computing device 130 of FIG. 1, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes a communications bus, which provides communications between computer processor(s) 404, memory 406, cache 416, persistent storage 408, communications unit 410, and input/output (I/O) interface(s) 412. Communications bus can be implemented with any architecture designed for passing data and/or control information between processors (such as microprocessors, communications and network processors, etc.), system memory, peripheral devices, and any other hardware components within a system.

Memory 406 and persistent storage 408 are computer readable storage media or computer readable storage devices. In this embodiment, memory 406 includes random access memory (RAM). In general, memory 406 can include any suitable volatile or non-volatile computer readable storage media. Cache 416 is a fast memory that enhances the performance of processor(s) 404 by holding recently accessed data and data near accessed data from memory 406.

Program instructions and data used to practice embodiments of the present invention may be stored in persistent storage 408 for execution by one or more of the respective processor(s) 404 via cache 416 and one or more memories of memory 406. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external device(s) 418 such as a keyboard, a keypad, a touch screen, and/or some other suitable input device. External device(s) 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used, for example, in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for evaluating generation of digital content, the method comprising:
receiving, by one or more computer processors, a request for a digital content to be sent to a mobile computing device of a user;
retrieving, by one or more computer processors, a plurality of local context information from the mobile computing device;
generating, by one or more computer processors, the digital content, based, at least in part, on the request and a first set of composition rules;
sending, by one or more computer processors, the digital content to the mobile computing device;
retrieving, by one or more computer processors, a plurality of user interaction information from the mobile computing device; and
analyzing, by one or more computer processors, the plurality of local context information and the plurality of user interaction information.

2. The method of claim 1, further comprising:
generating, by one or more computer processors, at least one report based, at least in part, on the analyzed information; and
determining, by one or more computer processors, whether the at least one report includes one or more adjustments to the first set of composition rules.

3. The method of claim 2, further comprising:
responsive to determining the at least one report includes one or more adjustments to the first set of composition rules, creating, by one or more computer processors, a second set of composition rules, based, at least in part, on the one or more adjustments;
receiving, by one or more computer processors, a request for a second digital content to be sent to the mobile computing device of the user; and
generating, by one or more computer processors, a second digital content based, at least in part, on the second set of composition rules.

4. The method of claim 2, wherein the one or more adjustments are based, at least in part, on a difference between the plurality of user interaction information and a user profile information of the user.

5. The method of claim 1, wherein the plurality of user interaction information includes at least one of: an intentional user interaction with the digital content and a non-intentional user interaction with the digital content.

6. The method of claim 1, wherein the step of analyzing the plurality of local context information and the plurality of user interaction information further comprises:
retrieving, by one or more computer processors, user profile information of the user;
analyzing, by one or more computer processors, a part of the digital content based, at least in part, on the user profile information, the plurality of local context information, and the plurality of user interaction information;
analyzing, by one or more computer processors, a composition rule of the first set of composition rules used to generate the part of the digital content; and
determining, by one or more computer processors, a quality of the part of the digital content based, at least in part, on the composition rule used to generate the part of the digital content and the analysis of the part of the digital content.

7. The method of claim 1, wherein the plurality of local context information from the mobile computing device includes at least one of: a time, a location, one or more activities, a social setting, and a culture.

8. A computer program product for evaluating generation of digital content, the computer program product comprising a computer readable storage medium having program instructions embodied therewith, the program instructions executable by a computer processor to cause the computer processor to perform a method comprising:
receiving, by one or more computer processors, a request for a digital content to be sent to a mobile computing device of a user;
retrieving, by one or more computer processors, a plurality of local context information from the mobile computing device;
generating, by one or more computer processors, the digital content, based, at least in part, on the request and a first set of composition rules;
sending, by one or more computer processors, the digital content to the mobile computing device;
retrieving, by one or more computer processors, a plurality of user interaction information from the mobile computing device; and
analyzing, by one or more computer processors, the plurality of local context information and the plurality of user interaction information.

9. The computer program product of claim 8, further comprising:
generating, by one or more computer processors, at least one report based, at least in part, on the analyzed information; and
determining, by one or more computer processors, whether the at least one report includes one or more adjustments to the first set of composition rules.

10. The computer program product of claim 9, further comprising:
responsive to determining the at least one report includes one or more adjustments to the first set of composition rules, creating, by one or more computer processors, a second set of composition rules, based, at least in part, on the one or more adjustments;
receiving, by one or more computer processors, a request for a second digital content to be sent to the mobile computing device of the user; and
generating, by one or more computer processors, a second digital content based, at least in part, on the second set of composition rules.

11. The computer program product of claim 9, wherein the one or more adjustments are based, at least in part, on a difference between the plurality of user interaction information and a user profile information of the user.

12. The computer program product of claim 8, wherein the plurality of user interaction information includes at least one of: an intentional user interaction with the digital content and a non-intentional user interaction with the digital content.

13. The computer program product of claim 8, wherein the step of analyzing the plurality of local context information and the plurality of user interaction information further comprises:
retrieving, by one or more computer processors, user profile information of the user;
analyzing, by one or more computer processors, a part of the digital content based, at least in part, on the user profile information, the plurality of local context information, and the plurality of user interaction information;
analyzing, by one or more computer processors, a composition rule of the first set of composition rules used to generate the part of the digital content; and
determining, by one or more computer processors, a quality of the part of the digital content based, at least in part, on the composition rule used to generate the part of the digital content and the analysis of the part of the digital content.

14. The computer program product of claim 8, wherein the plurality of local context information from the mobile computing device includes at least one of: a time, a location, one or more activities, a social setting, and a culture.

15. A computer system for evaluating generation of digital content, the computer system comprising:
one or more computer processors;
one or more computer readable storage devices;
program instructions stored on the one or more computer readable storage devices for execution by at least one of the one or more computer processors, the program instructions comprising:
program instructions to receive a request for a digital content to be sent to a mobile computing device of a user;
program instructions to retrieve a plurality of local context information from the mobile computing device;
program instructions to generate the digital content, based, at least in part, on the request and a first set of composition rules;
program instructions to send the digital content to the mobile computing device;
program instructions to retrieve a plurality of user interaction information from the mobile computing device; and
program instructions to analyze the plurality of local context information and the plurality of user interaction information.

16. The computer system of claim 15 further comprising:
program instructions to generate at least one report based, at least in part, on the analyzed information; and
program instructions to determine whether the at least one report includes one or more adjustments to the first set of composition rules.

17. The computer system of claim 16, further comprising:
responsive to determining the at least one report includes one or more adjustments to the first set of composition rules, program instructions to create a second set of composition rules, based, at least in part, on the one or more adjustments;
program instructions to receive a request for a second digital content to be sent to the mobile computing device of the user; and
program instructions to generate a second digital content based, at least in part, on the second set of composition rules.

18. The computer system of claim 16, wherein the one or more adjustments are based, at least in part, on a difference between the plurality of user interaction information and a user profile information of the user.

19. The computer system of claim 15, wherein the plurality of user interaction information includes at least one of: an intentional user interaction with the digital content and a non-intentional user interaction with the digital content.

20. The computer system of claim 15, wherein the step of analyzing the plurality of local context information and the plurality of user interaction information further comprises:
program instructions to retrieve user profile information of the user;
program instructions to analyze a part of the digital content based, at least in part, on the user profile information, the plurality of local context information, and the plurality of user interaction information;
program instructions to analyze a composition rule of the first set of composition rules used to generate the part of the digital content; and
program instructions to determine a quality of the part of the digital content based, at least in part, on the composition rule used to generate the part of the digital content and the analysis of the part of the digital content.
